(19) United States
(12) Patent Application Publication
(10) Pub. No.: US 2004/0186807 A1
(43) Pub. Date: Sep. 23, 2004

(54) Credit data collection method and apparatus

(76) Inventors: Michael G. Nathans, Annapolis, MD (US); Marcia A. Goldstein-Nathans, Annapolis, MD (US)

Correspondence Address: Supervisor, Patent Prosecution Services, PIPER RUNDICK LLP, 1200 Nineteenth Street, N.W., Washington, DC, 20036-2412, US

(21) Appl. No.: 10/392,849

(22) Filed: Mar. 21, 2003

(51) Int. Cl. G06F 17/60

(52) U.S. Cl. 705/38

(57) ABSTRACT

A consumer arranges for a verifiable source to provide credit terms pertaining to a credit agreement to a data repository. The consumer and/or the creditor arranges with a financial institution such as a bank to report payment data to the data repository. The financial institution may be associated with either the consumer or the credit provider. The financial institution(s) reports the amounts and timing of payments to the data repository. The payment information preferably includes the actual date of the payment. The payment information is compared to the credit terms and compliance information is provided to potential credit providers directly and/or through reporting to traditional credit bureaus.

### BACKGROUND OF THE INVENTION

The present invention relates generally to the field of credit reporting and more particularly to the field of credit payment data collection and verification methods.

Traditionally, credit-worthiness is calculated based on credit payment data collected from creditors using automated methods. Traditional credit bureaus use this credit payment data to automatically calculate FICO (Fair, Isaac & Co.) credit scores for their subscribers using FICO's proprietary algorithms. These FICO credit scores are in turn used by automated underwriting and credit application scoring models to determine the risk of default and credit pricing. The FICO credit scores often ultimately determine whether the applicant will qualify for the credit sought.

Distinct social and racial disparities associated with this other-wise effective traditional automated underwriting credit risk management technology have been observed, especially in connection with low and moderate income consumers, first-time homebuyers, and consumers with rehabilitated credit. In order to qualify for credit, such consumers must establish credit-worthiness using the traditional credit instruments and payment history collection and reporting practices. However, the traditional methods used to establish credit-worthiness present distinct unfair disadvantages, especially to fiscally responsible low- and moderate-income consumers who pay their residential rent or mortgage, utilities, phone, retail credit bills on time, but who do not have other lines of credit.

A significant cause of this problem is that many smaller creditors and “non-traditional” creditors such as apartment rental landlords, utility, day care and telephone service providers do not report to traditional credit bureaus because of technical barriers, lack of convenience, or, in the case of unscrupulous lenders, a desire to keep good paying consumers from qualifying for credit on better terms from other lenders. This results in many borrowers that faithfully pay on time not receiving recognition for such payments by automated credit underwriting technologies that rely on automated payment data from the credit bureaus. Thus, the FICO scores generated for such low- and moderate-income consumers who do not have traditional lines of credit, do not own their own homes, and/or whose mortgages are serviced by a non-reporting mortgage servicer are based solely on traditional credit history (which is defined as credit for retail goods and services such as car loans or credit cards). The resulting FICO scores are therefore either non-existent or lower than they should be, resulting in higher cost of credit or inability to obtain credit for such consumers.

Furthermore, FICO scores that are based solely on traditional credit information, and that do not take into account housing payments, are not as accurate in predicting the likelihood of default on a residential mortgage or lease as a credit score in which housing credit data (if electronically accessible) is assessed. This is because the correlation between an applicant's past housing credit payment behavior and their future housing credit payment behavior is believed to be a stronger (and thus a more accurate indication of probability of default) than the correlation between past retail credit only payment behavior and future housing credit payment behavior.

There are yet other problems associated with traditional credit reporting methods. There is no check of the accuracy of the payment information that is reported to “traditional” credit bureaus. This is problematic for two reasons. First, it subjects consumers to potentially unscrupulous and unilateral payment reporting actions of creditors. Second, and of greatest concern, a consumer who rightfully withholds a payment due to a legitimate dispute (such as a landlord's failure to provide heat in the winter, running water, or sanitary plumbing) can receive a “black mark” using “traditional” credit reporting methods, and have their credit damaged for many years because of the rightful withholding of payment. This potential threat effectively prejudices a consumer's legal rights in a residential lease transaction using “traditional” credit reporting methods.

Second, the traditional methods do not effectively protect the consumer's rights in the data collection process. Third, the traditional methods do not reduce the cost of processing payments. Furthermore, in many cases no effort has been made to collect residential mortgage payment data from so-called “subprime” lenders while assuring privacy of the creditor/debtor relationship.

Yet another shortcoming of traditional consumer credit data collection involves the granularity of the available data. Traditional systems only make available to credit providers data indicating that payments are on time or late in 30 day increments, e.g., 30 days late, 60 days late, 90 days late, etc. However, especially in the case of a lender with a large portfolio, the amount of money associated with “float” can be substantial. Thus, it may be very valuable to know that a borrower pays his bills on the due date rather than 25 days after the due date. This information is not available with the traditional system.

What is needed is a credit data collection system and method that addresses these and other problems associated with the aforementioned traditional methods.

### SUMMARY OF THE INVENTION

The present invention provides a system and method for collecting credit payment history information. The invention lowers barriers to credit that are presented by prior art techniques for consumers who pay their residential rent, mortgage, utilities, day care and phone bills on time by collecting, managing, and making this payment history data electronically available to authorized subscribers for permissible purposes as defined by the Fair Credit Reporting Act. Subscribers may rely on data collected, managed and made available by the invention as inputs to drive their automated underwriting and credit pricing models.

In one aspect of the invention, the source of credit payment data is not limited to the creditor and can include, at the consumer's option, the consumer's financial institution, the creditor's financial institution, and/or as any intermediate financial institution. This aspect of the invention encourages consumers to utilize traditional financial institutions (e.g., banks) to make payments to creditors rather than making cash payments. This aspect of the invention also empowers a consumer who reliably makes payments to a non-reporting creditor to establish a good credit history without any consent or effort on the part of the creditor being required. Indeed, the creditor may not even be aware that the consumer is participating in the process in some embodiments.

In one embodiment of the invention, a consumer arranges for a verifiable source to provide credit terms (e.g., payment amounts and due dates) to a data repository. The verifiable source may be a creditor, landlord, bank, certified public accountant, law firm, credit counselor, realtor, mortgage broker, or other party. In preferred embodiments, the credit terms are entered via a website associated with the credit data repository. The consumer and/or the creditor arranges with a payment processor such as a bank to report payment data to the data repository. The payment processor may be associated with either the consumer or the credit provider. Preferably, the only information given to the payment processor is a tracking number and information as to whom the payment data is to be reported, to whom the payment is to be credited, and to whom the payment is to be debited. The tracking number is a number that is unique to a consumer in the same sense that a social security number is unique to a participant in that system, but that does not comprise personally identifiable information that would identify the consumer as would a social security number. The financial institution(s) reports the amounts and timing of payments to the data repository. The payment information preferably includes the actual date of the payment. The payment information is compared to the credit terms and compliance information is provided to potential credit providers directly and/or through reporting to traditional credit bureaus.

In another aspect of the invention, the credit data maintained in the repository is used to report a residential housing score in which residential housing credit payment history is more heavily weighted than retail credit payment history. In some embodiments, the residential housing credit payments include mortgage, day care, lease, utility, and phone bill payment information. The inducement for mortgage servicers to report mortgage payment information is provided by protecting the confidentiality of the creditor/debtor relationship, and by allowing mortgage services who do report payment information to access the information in a single centralized housing credit repository with the consent of the consumer. For housing credit risk management, this credit information adds considerable value to credit scores from “traditional” credit bureaus because it includes residential housing credit information, which is more predictive of future housing credit payment behavior than the information “traditionally” available from credit bureaus. The automated credit information also saves lenders the considerable expense of manually verifying recurring payments not reported to traditional credit bureaus.

Another aspect of the invention provides a security system to protect against unauthorized release of a consumer's credit data from the repository. In preferred embodiments of the invention, each consumer is provided with a PIN (personal identification number) and a password. Furthermore, member creditors are assigned Subscriber numbers, which are to be maintained in confidence. Member Subscribers are creditors who have registered with the data repository and who have legitimate credit risk management needs for the information, e.g., landlords, mortgage lenders, etc. In order for any consumer credit information from the repository to be transferred to any creditor, the consumer must authorize the release of the information to that creditor.

### BRIEF DESCRIPTION OF THE DRAWINGS

A more complete appreciation of the invention and many of the attendant advantages and features thereof will be readily obtained as the same becomes better understood by reference to the following detailed description when considered in connection with the accompanying drawings, wherein:

FIG. 1 is a flow diagram for a residential housing credit data method according to one embodiment of the present invention.

FIG. 2 is an exemplary enrollment form according to an embodiment of the invention.

FIG. 3 is a block diagram of a credit data collection system according to an embodiment of the invention.

### DETAILED DESCRIPTION

The present invention will be discussed with reference to preferred embodiments. Specific details are set forth in order to provide a thorough understanding of the present invention. However, the preferred embodiments discussed herein should not be understood to limit the invention. The invention is believed to be particularly applicable to consumer housing credit data and therefore will be discussed in that context below but should not be understood to be limited to consumer credit and/or housing credit. Furthermore, for ease of understanding, certain method steps are delineated as separate steps; however, these steps should not be construed as necessarily distinct nor order dependent in their performance.

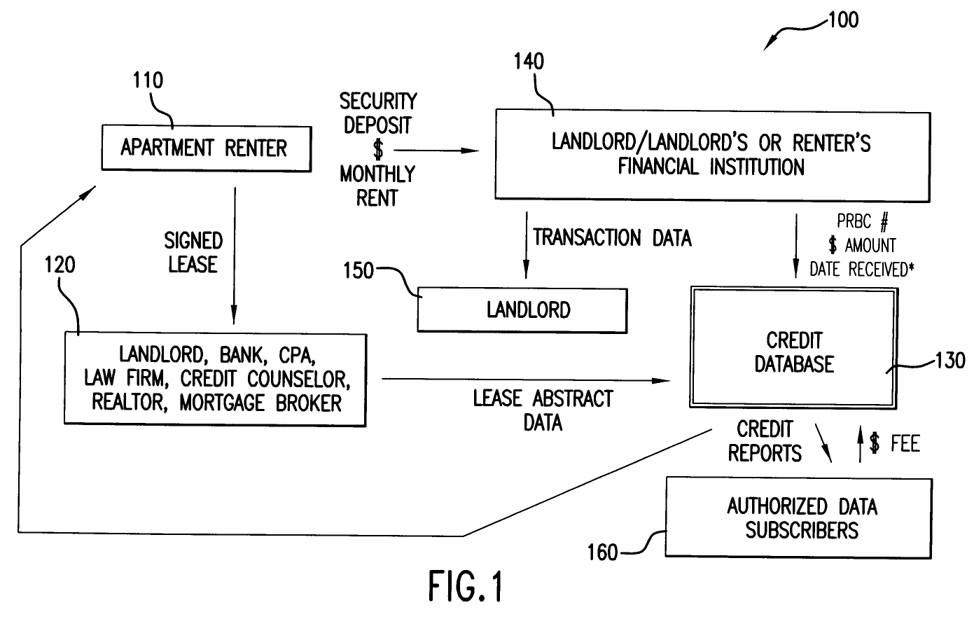

FIG. 1 is a flow diagram 100 according to one embodiment of the invention. A consumer such as an apartment renter 110 may begin the process by arranging to have credit terms input by a verifiable source 120 to a credit database 130. The verifiable source is preferably a person who is motivated to provide accurate information to the credit database 130 and/or who is accountable for inaccurate information. In some embodiments, the verifiable source 120 has a contractual relationship with the operator of the credit database 130.

The verifiable source 120 may be the landlord from whom the consumer rents. The verifiable source 120 may also be a professional such as an attorney or certified public accountant, or a realtor, mortgage broker, or some other publicly-licensed entity. It is also possible for the verifiable source 120 to be a financial institution such as a bank or credit union.

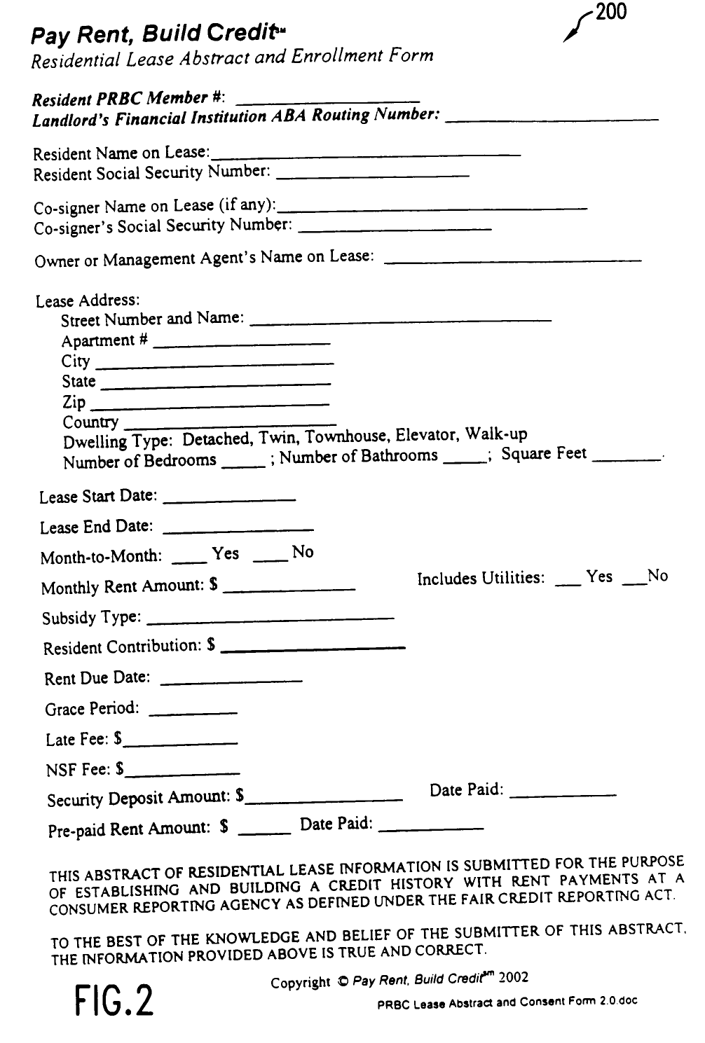

The credit terms that are provided by the verifiable source 120 preferably include the consumer's name and address and the payment amounts and due dates. In the case of an apartment renter, this information corresponds to the amount of the rent and the day of the month on which the rent is due. Other information, such as that indicated on the exemplary form 200 of FIG. 2 may also be collected. In highly preferred embodiments, the information from the verifiable source 120 is transmitted to the database 130 via an Internet website. In other embodiments, traditional methods (e.g., paper forms sent by mail) are also supported.

When the verifiable source 120 is different from the creditor/landlord, the information from the verifiable source 120 is preferably sent to the creditor/landlord 150 for verification, even if the creditor/landlord 150 does not otherwise participate in the process. This helps to prevent fraud on the part of consumers, who might otherwise be tempted, for example, to enlist the help of an unscrupulous third party to enter a due date later than the actual due date in order to make late payments appear timely.

After the consumer 110 has arranged for the verifiable source 120 to transmit the credit terms to the credit database 130, the consumer 110 makes the required payments to a payment processor 140. The payment processor 140 may be a financial institution associated with either the consumer or the credit provider (e.g., either the renter or the landlord) such as a bank, credit union, or other financial services provider such as a Wells Fargo or check cashing store, or may be the credit provider itself. Preferably, creditors having sophisticated payment processing capabilities, such as certified property management accounting software, are allowed to act as payment processors 140.

The arrangement between the payment processor and the consumer may be made in advance of the payment or at the time of the payment, and the arrangement may be made for a single payment or for a series of payments. For example, a consumer may arrange with his or her bank for an automatic payment to be made to his/her landlord from his/her bank account on a monthly basis. Alternatively, a consumer may take a paycheck to a check cashing store and arrange for some of the proceeds of the check to be paid to the creditor one month and may make a different arrangement (perhaps at a different store) the next month.

In preferred embodiments, the payments are made electronically. Electronic payments are preferred because they facilitate reporting payment information to the credit database 130. However, payments may also be made using traditional methods such as checks. In some embodiments, a lockbox is set up by the landlord at the landlord's financial institution, with arrangements made by the landlord to have the financial institution report payments made to the lockbox to the credit database 130.

It should be noted that it is possible for both the consumer and the landlord to arrange for payments to be reported. This might occur, for example, where a consumer initially makes these arrangements and a landlord later decides to have all payments made by residents reported by his financial institution. While such double reporting is not necessary, it can be accommodated. In fact, such an arrangement may prevent a mistake by one of the payment processors from being reported as a non-payment.

In preferred embodiments, when a consumer makes a payment to the payment processor 140, the payment processor 140 transmits the payment to the creditor's financial institution (or credits the payment to the creditor's account if the payment processor 140 is the landlord's financial institution) and reports the payment amount, the payment date and an identification number associated with the payment to the credit database 130. Preferably, the only information that is reported to the credit database 130 when a consumer makes a payment is the amount of the payment, the date of the payment, and an identification number corresponding to the consumer who made the payment. Because the credit term information is previously stored in the credit database 130, the payment processor 140 does not necessarily have any knowledge of the purpose of the payments and whether or not the payments are on time and constitute full payment. This promotes the privacy of the consumer.

When payment information is received from the payment processor 140 at the credit database 130, the payment information is compared to the corresponding credit terms and compliance information is calculated. The compliance information preferably indicates whether or not the payment is the full amount required per the corresponding credit agreement and how early or late the payment is. In some embodiments, the exact number of days by which the payment is early or late is reported. In other embodiments, the more traditional on time or 30/60/90 days late categorization is used. In some embodiments, rather than calculating compliance information, the credit terms and payment data are simply collected and reported, leaving it to the recipient of the information to determine whether the payments were made in compliance with the credit agreement.

The compliance information is made available to authorized subscribers, preferably for a fee. In preferred embodiments, the compliance information is only made available to those parties to whom the consumer has authorized release of the information (e.g., a landlord from whom the consumer wishes to rent).

Additionally, the consumer is granted access to his or her information, preferably via the Internet. The consumer's access may or may not be subject to a fee. The consumer may also enter comments in the database. For example, the consumer may designate a payment, including a late payment, as disputed. The consumer may also indicate that the date in the database 130 is incorrect. In some embodiments, information entered by the consumer will trigger an investigation by the credit database operator.

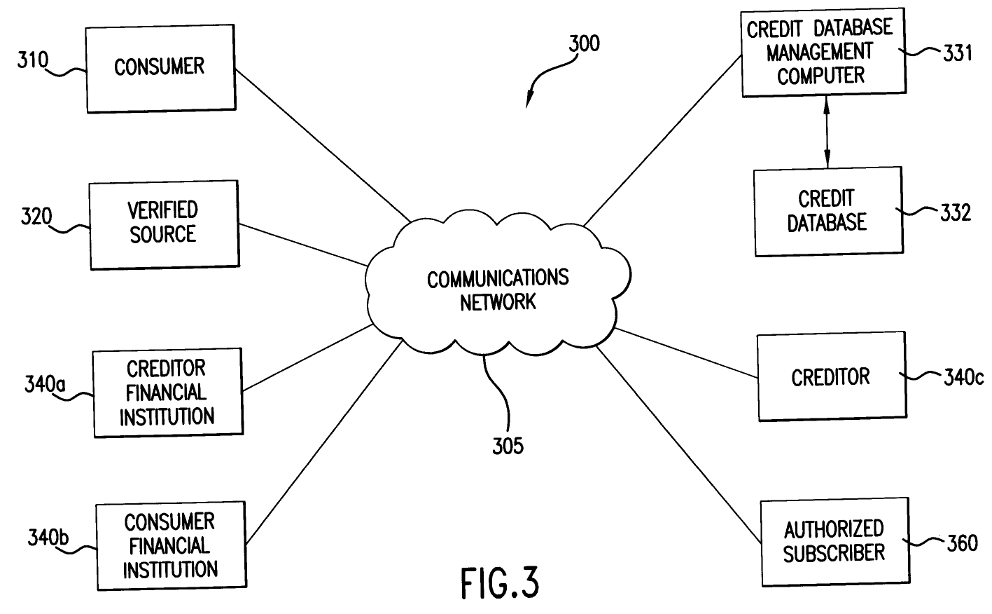

An exemplary system 300 according to the present invention is illustrated in FIG. 3. The system 300 includes a credit database management computer 331 which is connected to and manages a credit database 332. The credit database management computer 331 is connected to a communications network 305, which comprises the Internet in preferred embodiments. Also connected to the communications network is a verified source computer 320. Information pertaining to credit terms (e.g., lease payment amounts and due dates) is transmitted from the verified source computer 320 to the credit database management computer 331 for entry into the database 332.

Also connected to the communications network 305 are payment processors in the forms of a creditor financial institution computer 340a, a consumer financial institution computer 340b and a creditor computer 340c. The payments processor computers 340a, 340b and 340c report payment information to the credit database management computer 331 for entry into the credit database 332. Where the payment processor is different from the creditor, the payment processors 340a, 340b report payment information to the creditor computer 340c.

A consumer computer 310 is also connected to the communications network 305. The consumer uses the consumer computer 310 to verify the accuracy of the information in the credit database 332 and, if necessary, to annotate any discrepancies in the information in the credit database 332. At the consumer's option, the consumer computer 310 could also be used to make payments (e.g., the consumer could use the consumer computer 310 to instruct his/her bank to make a required payment if his/her bank supports on-line banking). Access to the information in the credit database 332 is protected by one or more well known methods such as password protection and/or more sophisticated methods such as bioscans, etc. Also connected to the communications network 305 is an authorized subscriber computer 360, which allows authorized subscribers to access credit information in the credit database 332.

It should be understood by those of skill in the art that the various computers illustrated in FIG. 3 are not necessarily separate. For example, a landlord's computer may take on the roles of the verified source 320, the creditor payment processor 340c, and the authorized subscriber 360. Similarly, a computer at a consumer's bank may play the part of the verified source 320 and the consumer financial institution 340b.

As discussed above, the invention is believed to be particularly applicable to residential housing credit such as apartment rentals and leases but is capable of much broader application. The invention may be used in connection with almost any kind of credit, including child/day care, furniture rentals/purchases, mobile home pad rent, condominium and co-op fees, parking, phone, gas, electric and other utilities.

As discussed above, one of the motivating factors associated with the invention is to aid lower and middle income consumers to build good credit histories. The motivation for parties other than the consumer to participate in the process may come in a variety of forms. In the case of landlords, motivation may come in the form of reduced fees for credit reports from the database 130 for future prospective customers. Participation in the process by the landlord also reduces any effort required on the part of the consumer, which may be used by the creditor as a selling point. Furthermore, the knowledge on the part of the consumer that payments will affect credit ratings may provide further motivation to the consumer to make payments on time. Banks gain market advantage and build brand loyalty and are able to assess the credit risk of a broader population at lower cost and may receive favorable Community Reinvestment Act (CRA) credits and favorable publicity from participating in the process. In some embodiments, the verifiable source and/or the payment processor may charge a fee for collecting and transmitting the credit term information, thereby providing a financial incentive. Regardless of whether a fee is collected, the interaction with the consumer provides an opportunity to create a relationship with the consumer.

Obviously, numerous other modifications and variations of the present invention are possible in light of the above teachings. It should be understood that the invention may be applied to a wide range of credit situations, including residential housing credit, utility credit, retail credit including automobile and furniture loans and credit cards, etc. It is therefore to be understood that within the scope of the appended claims, the invention may be practiced otherwise than as specifically described herein.

What is claimed is:

1. A method for processing credit information comprising the steps of:
accepting credit term information corresponding to credit extended to a consumer by a creditor pursuant to a credit agreement;
accepting credit payment information from a payment processor designated by the consumer, the credit payment information being indicative of payments made by the consumer pursuant to the credit agreement; and
reporting information indicative of compliance with the credit term information by the consumer.

2. The method of claim 1, wherein the credit agreement is a residential housing credit agreement.

3. The method of claim 1, wherein the credit agreement is a utility credit agreement.

4. The method of claim 1, wherein the credit agreement is a child care credit agreement.

5. The method of claim 1, wherein the credit term information is accepted from the creditor.

6. The method of claim 1, wherein the credit term information is accepted from the payment processor.

7. The method of claim 1, wherein the credit term information is accepted from a party other than the consumer, the payment processor, and the creditor.

8. The method of claim 1, wherein the credit agreement is a written agreement.

9. The method of claim 1, wherein the credit payment information includes an identification number corresponding to the credit agreement.

10. The method of claim 1, wherein the credit payment information consists solely of an identification number, a payment amount, and a payment date.

11. The method of claim 1, further comprising the step of soliciting verification of the credit term information from the creditor.

12. The method of claim 1, wherein the verifiable source is the consumer's bank.

13. The method of claim 1, wherein the verifiable source is an attorney.

14. The method of claim 1, wherein the verifiable source is an accountant.

15. The method of claim 1, further comprising the step of accepting an authorization from a consumer to release the information indicative of compliance with the credit term information, wherein the reporting step is only upon receipt of the authorization.

16. The method of claim 1, wherein the information reported in the reporting step allows one to determine an exact number of days by which any payment is late.

17. The method of claim 16, wherein the information reported in the reporting step includes an exact date on which payments were made and an exact amount of the payments.

18. A method for building a credit history comprising the steps of:
entering into a credit agreement with a creditor;
arranging for a first party to supply information pertaining to terms of the credit agreement to a credit reporting agency;
instructing a payment processor to payment information to the credit reporting agency; and
making payments pursuant to the credit agreement to the payment processor.

19. The method of claim 18, further comprising the step of authorizing the credit reporting agency to report information from which compliance of the payments to the terms of the credit agreement can be determined.

20. The method of claim 19, wherein the credit reporting agency is authorized to report the information to a traditional credit bureau.

21. The method of claim 19, wherein the credit reporting agency is authorized to report the information to a credit provider.

22. The method of claim 18, wherein the first party is the payment processor.

23. The method of claim 18, wherein the payment processor is a bank associated with the consumer.

24. The method of claim 18, wherein the payment processor is the creditor.

25. The method of claim 18, further comprising the steps of:
reviewing payment data maintained by the credit reporting agency; and
annotating data as incorrect.

26. A method for processing credit information comprising the steps of:
collecting payment information concerning a payment made by a consumer to a creditor, the payment information comprising a payment date and a payment amount; and
reporting compliance information allowing one to determine an exact number of days, if any, by which the payment is late.

27. The method of claim 26, wherein the payment information is collected from a financial institution.

28. The method of claim 27, wherein the compliance information comprises the payment date, the payment amount, and a date on which the payment was due.

29. The method of claim 27, wherein the compliance information comprises an exact number of days, if any, by which the payment is late.

30. The method of claim 27, wherein the financial institution reports the payment information based on a request made by the consumer.

31. The method of claim 27, wherein the financial institution reports the payment information based on a request made by the creditor.
